(19) United States
(12) Patent Application Publication
(10) Pub. No.: US 2010/0213768 A1
(43) Pub. Date: Aug. 26, 2010

(54) Apparatus for photovoltaic power generation

(76) Inventor: Alex Faveluke, Wilsonville, OR (US)

Correspondence Address: Garth Janke;Portland Intellectual Property, LLC, Suite 1820, 900 SW Fifth Avenue, Portland, OR, 97204, US

(21) Appl. No.: 12/660,275

(22) Filed: Feb. 24, 2010

Related U.S. Application Data
(60) Provisional application No. 61/208,425, filed on Feb. 24, 2009.

(51) Int. Cl. H02J 1/12

(52) U.S. Cl. 307/82

(57) ABSTRACT

An apparatus for photovoltaic power generation. The apparatus utilizes a two stage electrical power converter comprising a first converter stage for converting DC power produced by the one or more sources to converted DC power, and a second converter stage for inverting the DC power output of the first inverter stage to AC power. The first converter stage is adapted to function as a current source for sourcing current to the second converter stage to the extent of having an output impedance of at least 240 kOhms.

### RELATED APPLICATIONS

This application claims the benefit of Application Ser. No. 61/208,425, filed Feb. 24, 2009, which is incorporated by reference herein in its entirety.

### FIELD OF THE INVENTION

The present invention relates to an apparatus for photovoltaic power generation, specifically for converting electrical power produced by one or more photovoltaic power sources for provision to the power grid.

### BACKGROUND

Electric power is typically generated as alternating current (AC). This allows for easily converting the voltage either up or down by the use of transformers. Voltage is converted up for long distance transmission, typically to about 200-500 kV, to reduce resistive losses and the effects of power line impedance, down for local distribution, typically to about 2-34.5 kV, and further down to under 600 V at the point of use.

Electric power sources are typically fossil fuel power plants, hydroelectric plants, and nuclear plants, all of which turn a generator and produce AC directly. Wind power plants also employ generators that produce AC at the power source.

Solar power can also be produced by utilizing the sun's radiation to heat a working fluid that drives a turbine/generator to produce AC. On the other hand, photovoltaic (or solar) cells produce direct current (DC) according to principles of solid state physics. FIGS. 1 and 2 show, respectively, a typical photovoltaic cell 2 and its circuit equivalent. A single cell produces DC at very low voltage, e.g., 0.5 V. Therefore, to utilize photovoltaic energy as a source of utility power requires connecting such low voltage DC sources to the AC power grid.

To raise the voltage to a workable level for this purpose, individual cells are typically connected in series to form “modules” 4 (or “panels”), as shown in FIG. 3. For example, a module marketed under the trademark SUNPOWER utilizes 96 of the cells of FIG. 1 and has a rated voltage of 54.7 V.

It is understood that the voltage output of a solar cell depends primarily on the level of solar insolation or amount of light energy received, the temperature of the cell, and the characteristics of the load. For purposes herein, factors independent of the characteristics of the load shall be termed “native conditions.” Any solar cell, or group of solar cells, define, for a given set of native conditions, an optimum load to which the power delivered from the solar cell or group of solar cells is the maximum attainable. Thus, the power delivered to the optimum load is termed herein the “maximum power point” for such conditions.

As shown in FIG. 4, the modules are also connected in series, to form “strings” 6. To provide more power than is available from a single string, a number of strings are typically connected in parallel.

For connecting the strings to the power grid or other connected load, an inverter 8 is provided, in which the current is converted to AC, and the voltage is transformed to match that of the power grid, or otherwise meet the requirements of the connected load.

The term “converter” generically refers to a device that converts voltages, typically DC to AC or AC to DC, and in the present context, a converter is used to convert DC to AC in which case it is termed an “inverter.” The strings are connected to the inverter, which creates an alternating current by use of switching devices.

Converters can be provided in one of two major architectural classes: (1) self-commutated, of which the most common and practical example today is a pulse width modulation (“PWM”) voltage source converter; and (2) line commutated. The switching devices in line commutated converters are typically thyristors (aka silicon-controlled rectifiers or SCR's). The switching devices are switched off by reversals in line voltage, and are therefore switched at the relatively low power line frequency, typically 60 Hz.

PWM voltage source converters are typically implemented with insulated-gate bipolar transistors (IGBT's) as the switching devices, and are switched at relatively high frequencies.

Line commutated converters are typically not utilized in photovoltaic electrical power generation, as they are considered disadvantageous relative to PWM voltage source converters for a number of reasons. Foremost, the higher switching frequency of the PWM voltage source converter allows for minimizing power line harmonics, which are required by regulations to fall within limits that are very difficult to meet with a line commutated converter. In addition, the higher switching frequency allows for reducing the size of filtering components and the transformer required to convert the voltage. Another reason line commutated converters are considered disadvantageous is that, unlike PWM voltage source converters, they consume large amounts of reactive power, which negatively impacts grid efficiency and voltage control.

There are, however, some drawbacks of PWM voltage source converters, such as that they typically require a capacitor bank to maintain a low impedance DC voltage bus, and the higher switching frequency creates more switching loss and electromagnetic or radio frequency interference (EMI or RFI).

There is, therefore, a need for a method and apparatus for photovoltaic power generation that improves upon the architectures provided in the prior art.

### SUMMARY

An apparatus for photovoltaic power generation is disclosed herein. The apparatus utilizes a two stage electrical power converter comprising a first converter stage for converting DC power produced by the one or more sources to converted DC power, and a second converter stage for inverting the DC power output of the first inverter stage to AC power. The first converter stage is adapted to function as a current source for sourcing current to the second converter stage to the extent of having an output impedance of at least 240 kOhms.

The following features may be added to the basic apparatus above, separately or in any combination:

The second converter stage is preferably line commutated.

The first converter stage may include a feedback control system for adjusting the power drawn from the one or more sources in response to the output current of the first converter stage.

The first converter stage preferably includes a flyback converter and a controller for controlling the duty cycle thereof, so as to adjust the power drawn from the one or more sources.

Where the first converter stage includes a flyback converter and a controller for controlling the duty cycle thereof, the feedback control system is adapted for adjusting the duty cycle in response to the output current of the first converter stage.

In an exemplary system, there is at least one additional converter stage, for converting DC power produced by one or more additional sources, that provides its converted power output to the second converter stage in parallel with the converted power output of the first converter stage.

It is to be understood that this summary is provided as a means of generally determining what follows in the drawings and detailed description and is not intended to limit the scope of the invention. Objects, features and advantages of the invention will be readily understood upon consideration of the following detailed description taken in conjunction with the accompanying drawings.

### BRIEF DESCRIPTION OF THE DRAWINGS

FIG. 1 is a schematic diagram of a standard photovoltaic solar cell.

FIG. 2 is a schematic diagram of an equivalent circuit for the solar cell of FIG. 1.

FIG. 3 is schematic diagram of a standard module or panel of the solar cells of FIG. 1.

FIG. 4 is a schematic diagram of a prior art inverter having as an input thereto a number of “strings” of modules or panels, such as shown in FIG. 3, connected in series, the strings being connected in parallel.

FIG. 5 is a block diagram of an apparatus for photovoltaic power generation according to the invention.

FIG. 6 is a schematic diagram of a tracking converter portion of the apparatus of FIG. 5, according to the present invention.

FIG. 7 is a schematic diagram of a line interface inverter portion of the apparatus of FIG. 5, according to the present invention.

FIG. 8 is a schematic diagram of an uncontrolled rectifier bridge.

FIG. 9 is a plot of voltage versus time for the 3 phases of a 3 phase AC power line.

FIG. 10 is a plot showing, essentially, how reactive power drawn by a line commutated inverter from an AC power line varies with firing angle.

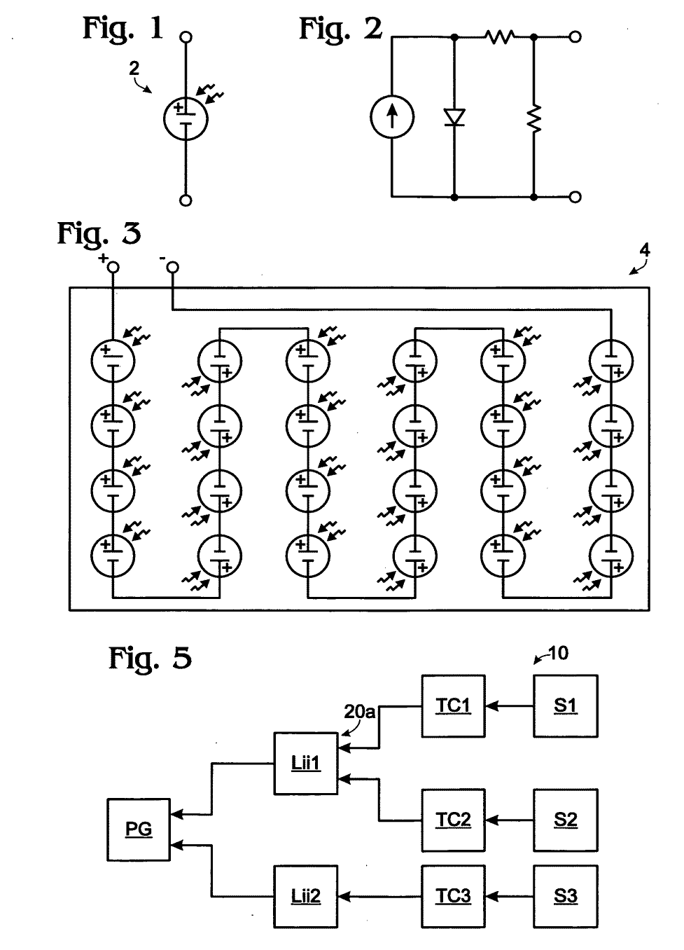

### DETAILED DESCRIPTION OF PREFERRED EMBODIMENTS

The invention provides two fundamental components, (1) a “tracking converter” (TC) that optimizes the power outputs of one or more modules or strings independent of the characteristics of the load; and (2) a “line interface inverter” (LII) for optimally converting the DC voltage outputs of one or more tracking converters.

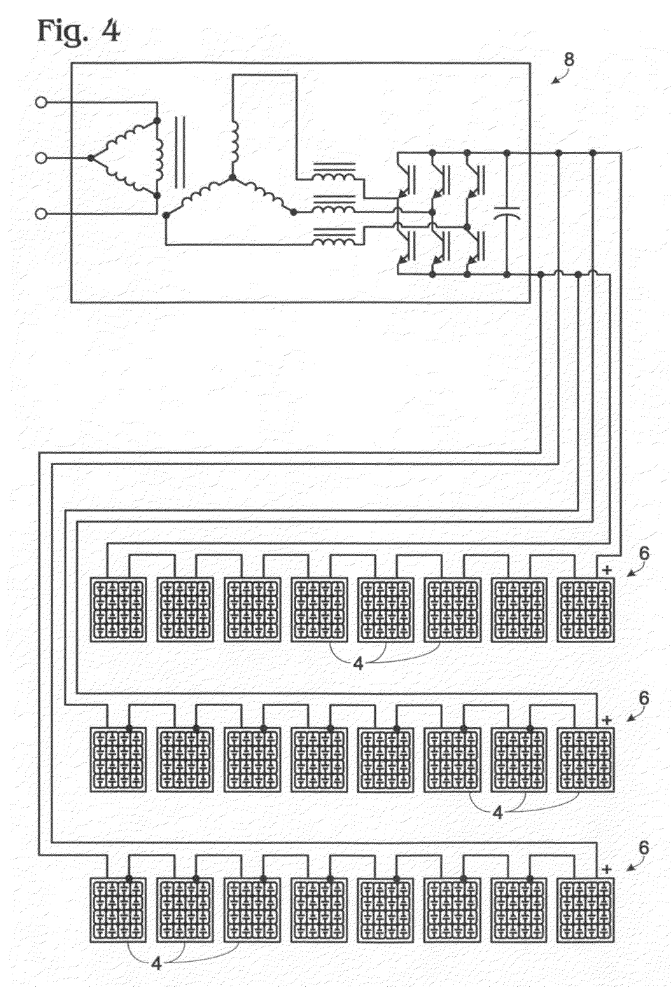

FIG. 5 shows an exemplary system configuration 10 in which there are three photovoltaic sources S1, S2, S3, three tracking converters TC1, TC2, and TC3, and two line interface inverters LII₁, LII₂. The power outputs of the sources S1, S2, and S3 are input to the tracking converters TC1, TC2, and TC3, respectively, i.e., each source has associated therewith its own tracking converter. The power outputs of the tracking converters TC1 and TC2 are connected in parallel and are input to the line interface inverter LII₁. The line interface inverter LII₂ preferably receives the output of a plurality of tracking converters as well, but in the exemplary configuration shown, the line interface inverter LII₂ receives as input the power output of a single tracking converter TC3.

The tracking converters TC boost the DC voltage outputs from the sources, and the line interface inverters LII convert the boosted DC voltage to AC. The outputs of the line interface inverters are connected to an existing power grid (PG).

According to the invention, the line interface inverters are line commutated. While the prior art disfavors line commutated converters, the alternative PWM converters have efficiency drawbacks as noted above. The present invention solves the problems associated with the use of line commutation by adaption of the tracking converters TC.

Tracking Converters

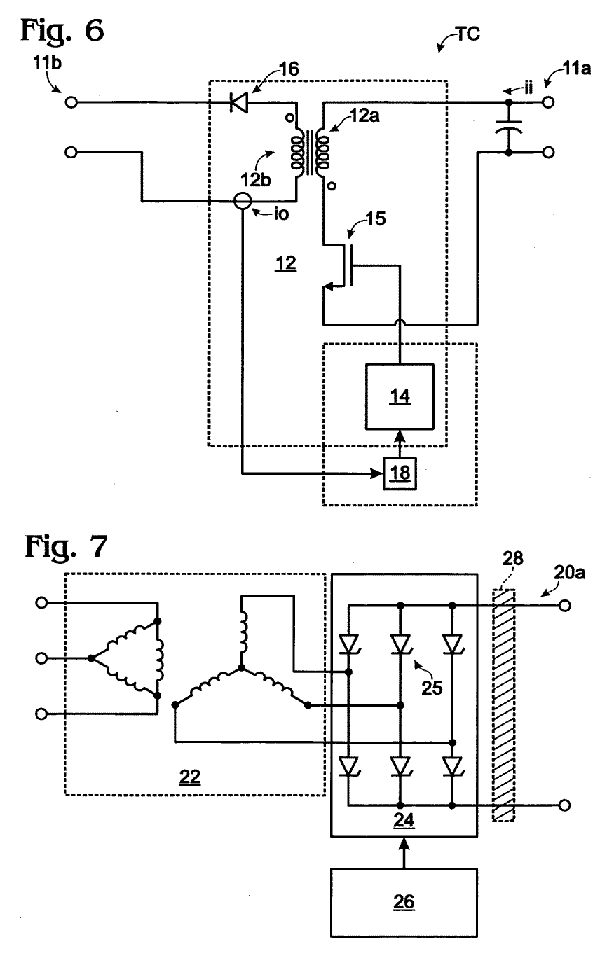

FIG. 6 shows a single tracking converter TC according to the present invention. The tracking converter converts the DC power provided by one or more photovoltaic power sources S as described below. The sources S may in general be one or more photovoltaic cells connected in series, parallel, or any combination thereof, but are preferably each a single photovoltaic panel having substantially the construction shown in FIG. 3.

The outputs of the sources S are applied in parallel to a converter input 11a of the tracking converter TC, and the tracking converter outputs, at a tracking converter output 11b, a current “i.”

A unique feature of the tracking converter is that it emulates a controlled current source, where the output current iₒ is controlled by the voltage produced by the sources. This provides the capability for coupling the outputs 11b of a number of tracking converters together in parallel (as shown in FIG. 5) as input to a line interface inverter without imposing any significant requirement on the voltage at the input of the line interface inverter. This frees the line interface inverter to set its own input voltage to a level at which inversion is most efficient.

This feature also avoids imposing any significant constraint on the voltage or current at the input 11a, which enables the tracking converter to draw the maximum power from the one or more sources.

A preferred manner of implementing a controlled current source, for reasons of simplicity and cost, is to use a flyback converter 13. In the flyback converter, current through an input coil 12a is switched by a control element 14 controlling a switch 15 to provide a repetitive input duty cycle wherein, for a first period of time current provided at the input 11a is allowed to flow through the coil 12a, and for a temporally adjacent second period of time, the current is switched off. On the output side of the flyback converter, a switching element 16 which in the preferred embodiment is a diode as shown is provided in series with the output coil 12b. The coils 12a and 12b are oriented as shown with opposing polarities. As a result of these arrangements, when current is flowing through the coil 12a it does not flow through the coil 12b and vice versa, thus isolating the input and output of the tracking converter.

While a flyback converter 13 is preferred, a controlled current source could be implemented in other ways as will be readily appreciated by persons of ordinary skill. In general, a real current source is modeled as an ideal current source in parallel with an internal impedance that reflects the deviation of the current source from the ideal. The internal impedance should be high enough so that, when the current source is connected to a load, a large percentage of the current flows through the load and not the internal impedance. With this model in mind, the tracking converter emulates a current source to the extent of having an output impedance at 11b that is at least 240 kOhms, which provides for no more than about a 1.5 Watt internal power loss for a 300 Watt current output at 600V. More preferably, the output impedance of the tracking converter is at least 1.0 MOhms, and still more preferably it is at least 2.0 MOhms.

The control element 14 controls the switch 15 so as to maximize the power drawn from the source connected to its input 11a, particularly by controlling the draw of current iᵢ. As mentioned above, there is an optimum power point at which the current is optimum to maximize the power output of the source. The tracking converter TC includes a control element 19 comprising the control element 14 and a sensing element 18 that monitors conditions determinative of the power drawn from the source, at the tracking converter input 11a. The control element 14 includes a feedback control system adapted to perform what is known in the art as MPPT (“maximum power point tracking”). The feedback control system can be implemented any number of ways as will be readily appreciated, and it may straightforwardly monitor the voltage and current at the input by use of the sensing element 18, convert these measurements to digital form (in an analog to digital converter that is not shown), compute the power in a processor in the control element 14, and adjust the duty cycle upwardly or downwardly in small increments as needed to maintain a maximum value of the computed power.

However, preferably, the feedback control system takes advantage of unique features of the present invention, to facilitate MPPT. As mentioned above, and as will be explained more fully below, the tracking converter output current iₒ is input to a line interface inverter which establishes the voltage at the tracking converter output 11b. This voltage can be assumed to be constant, and it can be assumed that the power loss in the tracking converter is also relatively constant. It is then recognized that a proxy for the power drawn from the sources is the output current iₒ, and no computation is required. Therefore, the sensing element 18 in the preferred embodiment senses the current iₒ, and the control element 14 maximizes the value of this current.

Line Interface Inverters

Returning to FIG. 5, the outputs of, preferably though not necessarily, a number of tracking converters TC, are each provided, preferably in parallel, to a single line interface inverter LII at an input 20a thereof, such as exemplified by the tracking converters TC1 and TC2, and the line interface inverter LII₁.

FIG. 7 shows a representative line interface inverter LII that includes a transformer 22 for transforming the utility distribution voltage, which may for example be 13.8 kVAC, to a practical voltage for inverter operation, such as 450 VAC.

Inversion is accomplished by a bridge 24 of line commutated switching devices 25, preferably thyristors. The bridge 24 supplies the primary side 22a of the transformer, and is controlled by a control module 26. Preferably a filter 28 is provided at the input of the bridge 24.

The control module 26 functions to control the line interface inverter LII so that it accepts the current source outputs 11b at the “ideal” input voltage under varying AC line conditions, i.e., the DC input voltage at which the inverter produces the best possible ratio of fundamental power to harmonic output and reactive power consumption, which is also the ratio at which the inverter operates most efficiently.

More specifically, the control module 26 controls the firing of the thyristors 25 so as to change their phase delays, termed “firing angles” to provide for this increased efficiency. By controlling the firing angles of the thyristors 25, the control module 26 delays the times when the AC power grid (PG in FIG. 5) is connected to the (DC) LII input 20a. Depending on the length of the delays, the voltage waveform on the AC side can impose a high average or a low average voltage on the LII input.

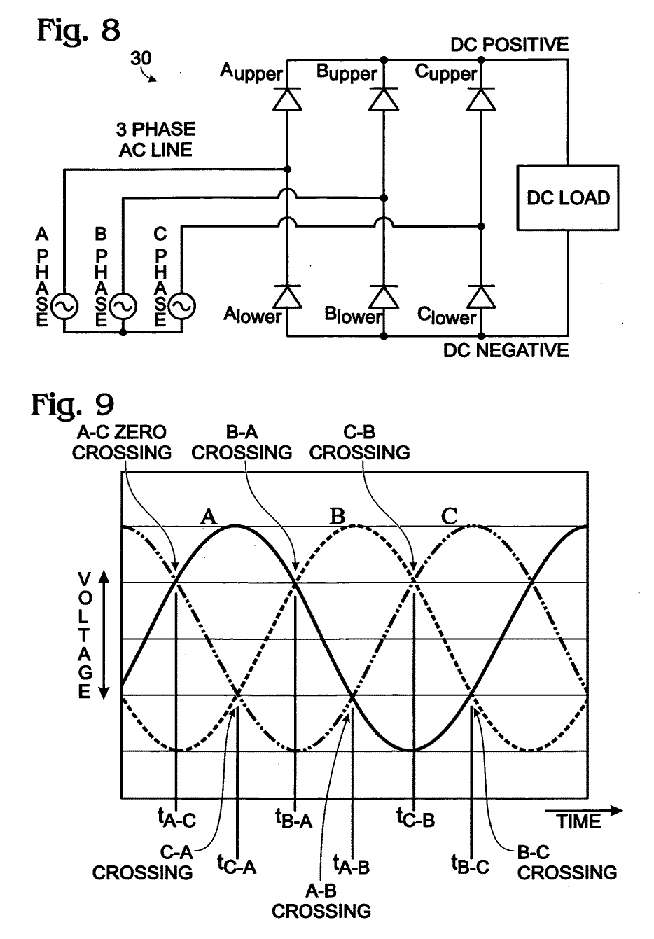

FIG. 8 shows an uncontrolled rectifier bridge 30 for reference, used for coupling DC to a typical 3 phase AC power line. There are 3 rectifier pairs, respectively, associated with the 3 phases of the AC line, each pair having an “upper” rectifier (Aᵤₚₚₑᵣ, Bᵤₚₚₑᵣ, Cᵤₚₚₑᵣ) associated with positive DC and a “lower” rectifier (A_{lower}, B_{lower}, C_{lower}) associated with negative DC. With 3 phase voltages as shown in FIG. 9, the rectifier indicated as Aᵤₚₚₑᵣ for example, will conduct, and therefore connect A phase voltage to positive DC, substantially as soon as the A phase voltage exceeds the B and C phase voltages, which more specifically in an A leads B leads C phase rotation occurs when the A voltage exceeds the C voltage, and first occurs at a time t_{A-C} at the point indicated as “A-C crossing.” Similarly, the rectifiers Bᵤₚₚₑᵣ and Cᵤₚₚₑᵣ will first conduct at a time t_{B-A} at the point indicated as “B-A crossing,” and at a time t_{C-B} at the point indicated as “C-B crossing,” respectively. The times t_{A-C} t_{B-A} and t_{C-B} may be referred to as upper uncontrolled rectifier firing times.

Conversely, where A is less than B and C, A_{lowr} conducts, connecting the A phase voltage to negative DC. This first occurs in an A leads B leads C phase rotation at a time t_{C-A} at the point indicated as “C-A crossing.” Similarly, the rectifiers B_{lower} and C_{lower} will first conduct at a time t_{A-B} at the point indicated as “A-B crossing,” and at a time t_{B-C} at the point indicated as “B-C crossing,” respectively. The times t_{C-A} t_{A-B} and t_{B-C} may be referred to as lower uncontrolled rectifier firing times.

According to the present invention, the uncontrolled rectifiers in the bridge 30 would be replaced by corresponding controlled rectifiers; preferably, the aforementioned thyristors 25 along with the controller 26. The controller 26 would provide for firing times for the 6 controlled rectifiers that are delayed from the uncontrolled rectifier firing times.

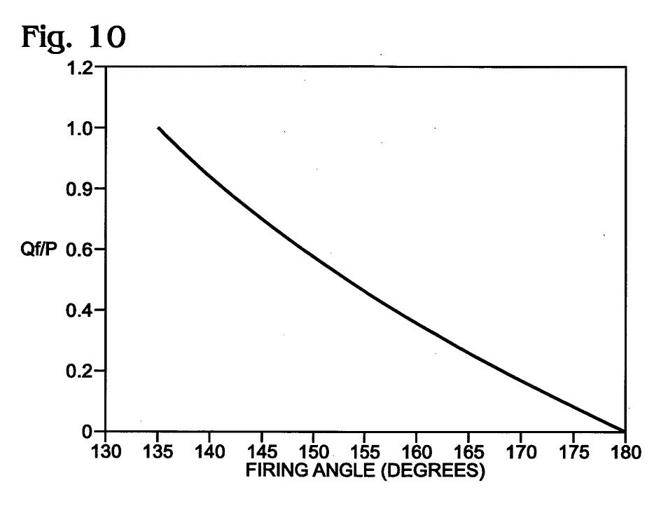

As a general rule, in a line commutated converter operating as an inverter the firing angles are controlled to be between 90 degrees, corresponding to an input voltage of 0, and 180 degrees, which is a theoretical firing angle corresponding to maximum input voltage. However, as shown in FIG. 10, reactive power Q (here plotted as the function Qf/P where f is the fundamental frequency—typically 60 Hz—and P is real power), drawn from the AC power grid by a line commutated converter, increases as the firing angle is decreased from 180 degrees.

As mentioned above, line commutated converters are disfavored in the art, for various reasons. An important one of these reasons is that line commutated converters are associated with very high reactive power consumption, due to low firing angles.

However, the provision of the tracking converters as described above adapted to drive current into voltage levels associated with firing angles set for the benefit of the associated LIIs mitigates what has been perceived in the art of photovoltaic power conversion to be a critical and decisive disadvantage of the use of line commutated inverters, a perception that has virtually prevented their use and the realization of their many other advantages. By contrast, if a line interface inverter were directly connected to a photovoltaic array instead of being connected to a tracking converter according to the invention, the line interface inverter would be required to operate over a wide range of firing angle to provide for power point tracking of the array.

A preferred method for determining, by the controller 26, the closest practical approach to the optimum 180 degree firing angle is by the following formula for delay angle θ: Firing Angle (FA)=180−(commutation overlap angle (θ)+thyristor turn-off time (expressed as an angle relative to the period of the AC waveform)+a selected safety factor (which may be zero)). Alternative methods for controlling the line interface inverter so as to maintain the firing angle within a range of about 150-180 degrees may be used without departing from the principles of the invention; however, as is apparent, a non-zero commutation overlap angle θ and a non-zero thyristor turn-off time will prevent obtaining the ideal of a 180 degree firing angle.

The commutation overlap angle may be determined as follows:

cos θ=1−[Iᵢ·Xₖ/(sqrt(2))·Vₘₛ·sin(π/6)], where
Iᵢ=input current to the LII (constant);
Xₖ=AC line reactance (per phase); and
Vᵣₘₛ=RMS AC voltage

Another of the aforementioned reasons that line commutated converters have been disfavored in the art is the conventional wisdom that a large transformer would be needed to utilize the lower, line switching frequency of the grid. However, the present inventor has recognized that there is in reality no additional penalty to utilizing the lower, line switching frequency when connecting the system 10 to the grid, because there is typically a large transformer already existing at the connection to the grid.

Finally, it is recognized that the problem of power line harmonics can be minimized, such as by implementing the LII with a multiple winding 6 phase transformer (such as a delta/delta-wye) to create a 12 pulse converter, or by using phase shift transformers in conjunction with multiple III's.

It is to be understood that, while a specific apparatus for photovoltaic power generation has been shown and described as preferred, other configurations could be utilized, in addition to those already mentioned, without departing from the principles of the invention.

It should be specifically understood that, while tracking converters according to the invention permit the use of a line commutated inverter, which provides for best conversion efficiency, the tracking converters could be used with non-line commutated inverters and still provide the advantage of allowing the inverter to set its own input voltage and thereby achieve increased efficiency.

The terms and expressions which have been employed in the foregoing specification are used therein as terms of description and not of limitation, and there is no intention in the use of such terms and expressions to exclude equivalents of the features shown and described or portions thereof, it being recognized that the scope of the invention is defined and limited only by the claims which follow.

1. An apparatus for converting electrical power produced by one or more photovoltaic power sources, the apparatus comprising:
a first converter stage for converting DC power produced by the one or more sources to converted DC power; and
a second converter stage for inverting the converted DC power to AC power, wherein said first converter stage is adapted to function as a current source for sourcing current to said second converter stage to the extent of having an output impedance of at least 240 kOhms.

2. The apparatus of claim 1, further comprising at least one additional converter stage for converting DC power produced by one or more additional sources, wherein converted DC power outputs of said first converter stage and said at least one additional converter stage are electrically coupled in parallel to a power input of said second converter stage, so that said second converter stage is enabled to invert the converted DC power provided by said first converter stage and said at least one additional converter stage.

3. The apparatus of claim 2, wherein said first converter stage and said at least one additional converter stage each include respective flyback converters and respective controllers for controlling the duty cycles thereof, so as to adjust the power drawn from said sources.

4. The apparatus of claim 3, wherein said first converter stage and said at least one additional converter stage each include respective feedback control systems for adjusting the respective said duty cycles in response to changes in the output currents of the respective converter stages.

5. The apparatus of claim 1, wherein said first converter stage includes a flyback converter, and a controller for controlling the duty cycle thereof, so as to adjust the power drawn from the one or more sources.

6. The apparatus of claim 5, wherein said first converter stage includes a feedback control system for adjusting said duty cycle in response to changes in the output current of said first converter stage.

7. The apparatus of claim 2, wherein said first converter stage and said at least one additional converter stage each include respective feedback control systems for adjusting the power drawn from the respective sources associated with said first converter stage and said at least one additional converter stage in response to the respective output currents of said first converter stage and said at least one additional converter stage.

8. The apparatus of claim 1, wherein said first converter stage includes a feedback control system for adjusting the power drawn from the one or more sources in response to the output current of the first converter stage.

9. The apparatus of claim 8, wherein said second converter stage is line commutated.

10. The apparatus of claim 7, wherein said second converter stage is line commutated.

11. The apparatus of claim 6, wherein said second converter stage is line commutated.

12. The apparatus of claim 5, wherein said second converter stage is line commutated.

13. The apparatus of claim 4, wherein said second converter stage is line commutated.

14. The apparatus of claim 3, wherein said second converter stage is line commutated.

15. The apparatus of claim 2, wherein said second converter stage is line commutated.

16. The apparatus of claim 1, wherein said second converter stage is line commutated.
